(19) United States
(12) Patent Application Publication
(10) Pub. No.: US 2025/0111419 A1
(43) Pub. Date: Apr. 3, 2025

(54) System and Method of Generating a Custom Greeting Card

(71) Applicant: Fernando Jackson, Norwalk, CA (US)

(72) Inventor: Fernando Jackson, Norwalk, CA (US)

(21) Appl. No.: 18/902,379

(22) Filed: Sep. 30, 2024

Related U.S. Application Data
(60) Provisional application No. 63/586,286, filed on Sep. 28, 2023.

(51) Int. Cl. G06Q 30/0601; B41M 3/00; B42D 15/02; G06F 3/12; G06T 11/60

(52) U.S. Cl. CPC G06Q 30/0621; B41M 3/005; B42D 15/02; G06F 3/1203; G06F 3/125; G06F 3/1288; G06T 11/60

(57) ABSTRACT

A system and method of generating a custom greeting card based on user preferences and recipient information is disclosed. The overall process begins by prompting a client account to enter order information for a custom greeting card order with a client computing device. The order information is then relayed to a remote server and the matrix barcode of a selected greeting card is edited with the order information using a barcode terminal. In addition, custom content message is generated based on the order information with the remote server. The custom content message is relayed to a greeting card printer and the barcode terminal. The selected greeting card is verified with the corresponding matrix barcode using the barcode terminal to ensure the correct greeting card is used. Finally, the custom content message is printed on the selected greeting card using the greeting card printer to generate the custom greeting card.

### FIELD OF THE INVENTION

The present invention relates generally to customization systems and greeting cards. More specifically, the present invention discloses novel means of generating custom greeting cards based on a user's information and preferences.

### BACKGROUND OF THE INVENTION

Greeting cards are a time-honored form of personal communication, typically made from paper or cardstock, and designed to convey sentiments, well-wishes, or greetings for various occasions and events. Greeting cards come in a wide array of designs, themes, and styles to suit diverse occasions, including birthdays, weddings, holidays, graduations, and more. Inside a greeting card, there is usually blank space for the sender to pen a personal message, adding a customized touch to the card's sentiment. Some greeting cards also include printed messages or poems that align with the occasion's theme. Further, personalized cards are becoming increasingly popular, as consumers seek to send more meaningful and unique greetings. Publishers are responding to this trend by offering a wider variety of personalized card options, such as cards with custom photos, messages, and designs. Alongside traditional paper greeting cards, electronic or e-cards have also gained popularity in the digital age by allowing people to send digital greetings via faster means of communication, such as email or social media, thus offering a more convenient and cost-effective way to send greeting cards. These alternatives have posed a challenge to the traditional greeting card industry, but publishers are responding by offering digital products and services. Unfortunately, current methods for creating customized greeting cards require substantial manual input, may create erroneous addresses, and often lack seamless integration throughout the creation and delivery process.

Therefore, an objective of the present invention is to provide a novel system and method of generating a custom greeting card. The present invention facilities the creation and distribution of customized greeting cards by implementing novel means to generate customized greeting card content. The present invention allows the generation of custom greeting card content based on user preferences to expedite the creation of the custom greeting card. The present invention implements different automated means of content generation, such as Artificial Intelligence (AI) engines, to expedite the creation of the custom greeting card. Further, the present invention can implement means to ensure that the generation of the custom greeting card follows user preferences and order details, such as implementing matrix barcodes on the greeting card and the corresponding card envelop. Additional features and benefits of the present invention are further discussed in the sections below.

### SUMMARY OF THE INVENTION

The present invention discloses a system and method of generating a custom greeting card based on user preferences and order instructions. The present invention discloses an automatic system that seamlessly creates and delivers customized greeting cards. In general, the customized greeting card of the present invention includes several card panels including, but not limited to, a cover panel, interior panels, a rear panel, etc. Further, the rear panel of the customized greeting card and the corresponding card envelop includes a matrix barcode, such as a Quick-Response (QR) code, that helps ensure the corresponding greeting card is customized according to the order details and sent to the appropriate recipient. Further, the system of the present invention implements a software platform that enables the user provide information necessary for the generation of the custom content for the corresponding greeting card as well as recipient information for shipping. The software platform can include different software applications developed for different computing devices, such as a mobile application for portable computing devices, desktop applications for laptops or desktop computers, etc.

Moreover, the system of the present invention can include a subscription module that enables the user to access different services provided by the software platform according to the subscription level acquired by the user. The present invention can also include a referral module that enables the user to refer other users to the services provided by the present invention. In addition, if referred users successfully join and acquire a subscription, the user can be given credits for future custom greeting card orders.

### BRIEF DESCRIPTION OF THE DRAWINGS

FIG. 1 is a schematic view showing the overall system of the present invention.

FIG. 2 is a flowchart illustrating the overall process of the method of the present invention.

FIG. 3 is a flowchart illustrating the continuation of the overall process of the method of the present invention.

FIG. 4 is a flowchart illustrating the subprocess of generating custom card content message using human staff.

FIG. 5 is a flowchart illustrating the subprocess of generating custom card content message using artificial intelligence (AI).

FIG. 6 is a flowchart illustrating the subprocess of customizing the selected greeting card using an uploaded picture.

FIG. 7 is a flowchart illustrating the subprocess of distributing the custom card content message throughout the card panels of the selected greeting card.

FIG. 8 is a flowchart illustrating the subprocess of logging custom greeting card orders on the client order database.

FIG. 9 is a flowchart illustrating the subprocess of acquiring a subscription of the present invention.

FIG. 10 is a flowchart illustrating the subprocess of enforcing subscription level limitations.

FIG. 11 is a flowchart illustrating the subprocess of enforcing the card content limitation based on the client's subscription level.

FIG. 12 is a flowchart illustrating the subprocess of facilitating the referral of the present invention to other users.

FIG. 13 is a flowchart illustrating the subprocess of including a gift card with the custom greeting card.

### DETAIL DESCRIPTIONS OF THE INVENTION

All illustrations of the drawings are for the purpose of describing selected versions of the present invention and are not intended to limit the scope of the present invention.

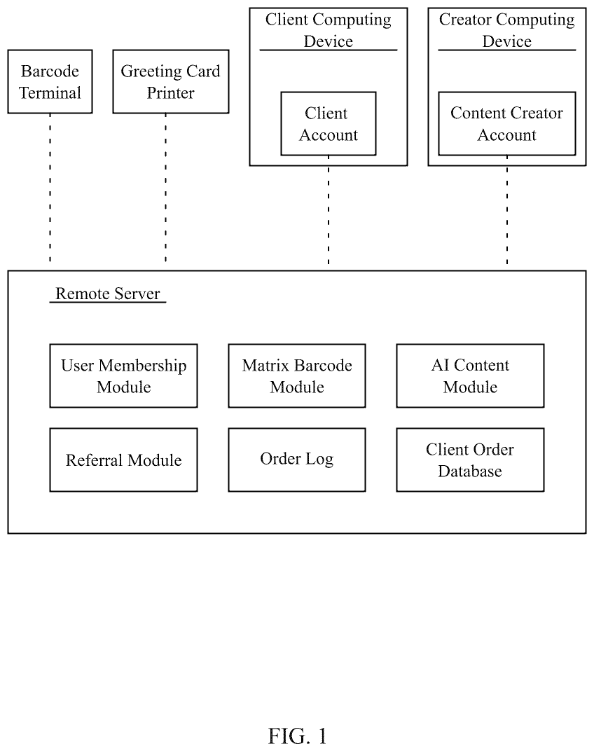

The present invention discloses a system and method of generating a custom greeting card based on user preferences and recipient information. The present invention provides an automated system that expedites the creation and delivery of custom greeting cards. In addition, the system of the present invention ensures that the custom greeting card uses the user preferences as a guide and that the custom greeting card is delivered to the correct recipient. As can be seen in FIG. 1, the system of the present invention generally includes at least one client account managed by at least one remote server (Step A). The client account corresponds to the user account created by the user that allows the user to access the software platform of the system of the present invention. In addition, the client account is associated with at least one client computing device. The client computing device can be any computing device that allows the user to access the software platform of the present invention. For example, the client computing device can include, but is not limited to, a desktop computer, a tablet computer, a laptop, a smartphone, etc. Further, a corresponding software application can be developed for the different computing devices that can be utilized such as, but not limited to, a mobile application, a desktop application, etc. Further, the system of the present invention implements means to help monitor the creation of the custom greeting card by using matrix barcodes. So, the remote server includes a matrix barcode module that facilitates the creation and editing of matrix barcodes that help ensure each custom greeting card is created according to user preferences and sent to the corresponding recipient.

In addition, the system of the present invention includes at least one greeting card printer and at least one barcode terminal managed by the remote server. As can be seen in FIG. 1, the greeting card printer facilitates the printing of the custom content on the corresponding greeting card template based on the client's preferences. The barcode terminal helps monitor the accurate creation and delivery of the custom greeting card by facilitating the verification of the different elements utilized to create and deliver the custom greeting card. Further, the system of the present invention includes a plurality of greeting cards that serve as blank cards for the creation of the custom greeting card. Each greeting card can come with a predetermined design, and each greeting card includes a corresponding matrix barcode. The matrix barcode can preferably be a Quick-Response (QR) code, but other types of matrix barcodes can be implemented. Further, the matrix barcode is integrated on the rear panel of the corresponding greeting card so that the matrix barcode can be used to verify the custom card content message to be printed on the greeting card.

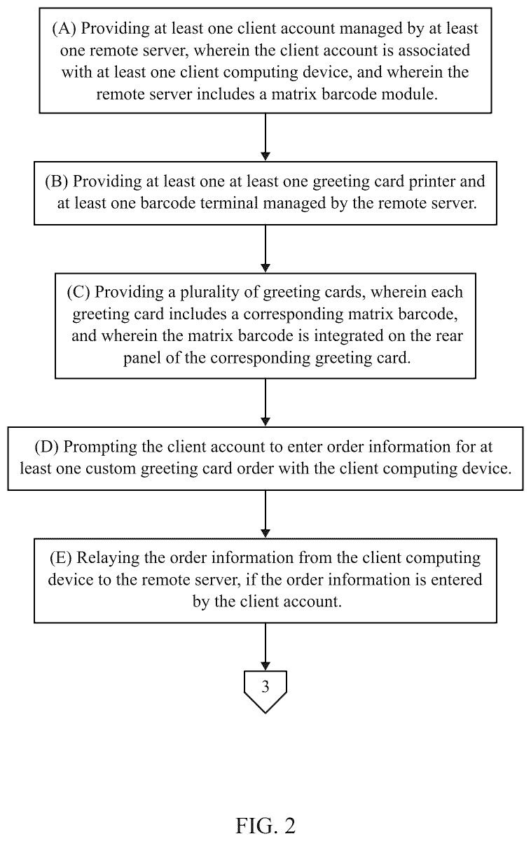

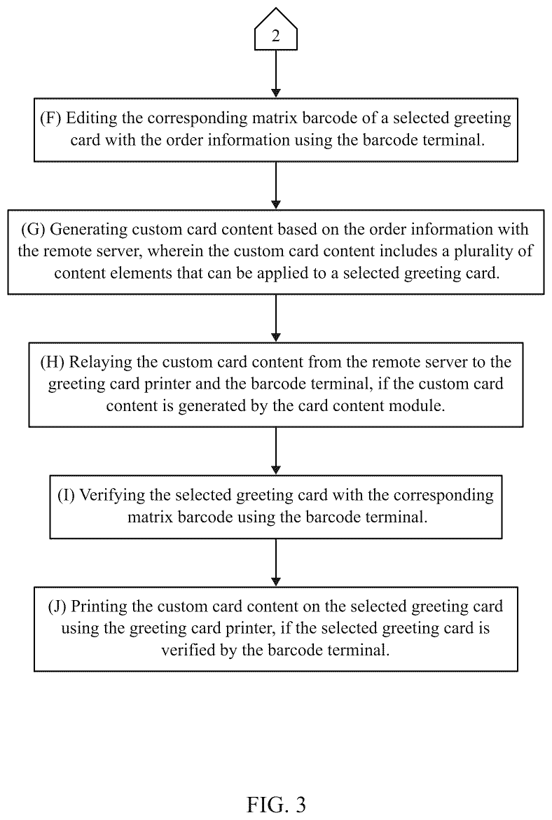

The system of the present invention enables the automated creation and delivery of the custom greeting card. As can be seen in FIGS. 2 and 3, the overall process of the method of the present invention begins by prompting the client account to enter order information for at least one custom greeting card order with the client computing device (Step D). The order information includes various information necessary for the generation of custom content and the delivery of the custom greeting card to the corresponding recipient. For example, the order information can include, but is not limited to, recipient's name, recipient relationship, recipient address, preferred language, card theme, card due date, recipient relationship description, holiday/occasion, recipient's birthday, or a combination thereof. Some order information can be designated as optional or required depending on the type of information that is used to generate the custom card content message.

As can be seen in FIGS. 2 and 3, once the client enters the order information with the client computing device, the order information is then relayed from the client computing device to the remote server (Step E), if the order information is entered by the client account. The remote server processes the order information so that the generation of custom card content message can be performed based on the order information. In addition, the corresponding matrix barcode of a selected greeting card is edited with the order information using the barcode terminal (Step F). Each of the plurality of greeting cards can be provided as a foldable blank card with different designs. A foldable blank card is selected based on the choice of the client provided on the order information for the custom greeting card. If the blank greeting card comes with a dynamic matrix barcode, then the corresponding matrix barcode is edited to assign the selected greeting card to the custom greeting card order. Otherwise, a new matrix barcode can be printed on the selected greeting card prior to the customization process to help staff maintain accuracy during the customization process and when shipping the finalized custom greeting card to the corresponding recipient.

As can be seen in FIGS. 2 and 3, custom card content message is generated based on the order information with the remote server (Step G). The custom card content message includes a plurality of content elements that can be applied to a selected greeting card. For example, the content elements can include, but is not limited to, custom written content such poetry writing, custom graphical content such as images or pictures, or a combination thereof, that can be printed or applied to the selected greeting card. The custom card content message is automatically generated based on the order information provided by the client so that the client does not have to come up with card content message. Once the custom card content message is generated, the custom card content message is relayed from the remote server to the greeting card printer and the barcode terminal (Step H). The custom card content message is relayed to the greeting card printer so that the custom card content message can be printed on the selected greeting card. Simultaneously, the custom card content message is relayed to the barcode terminal to help verify that the ordered custom card content message is printed on the selected greeting card. So, the selected greeting card is verified with the corresponding matrix barcode using the barcode terminal (Step I). This way, the selected greeting card is verified to be the correct greeting card according to the order information. Finally, the custom card content message is printed on the selected greeting card using the greeting card printer (Step J), if the selected greeting card is verified by the barcode terminal.

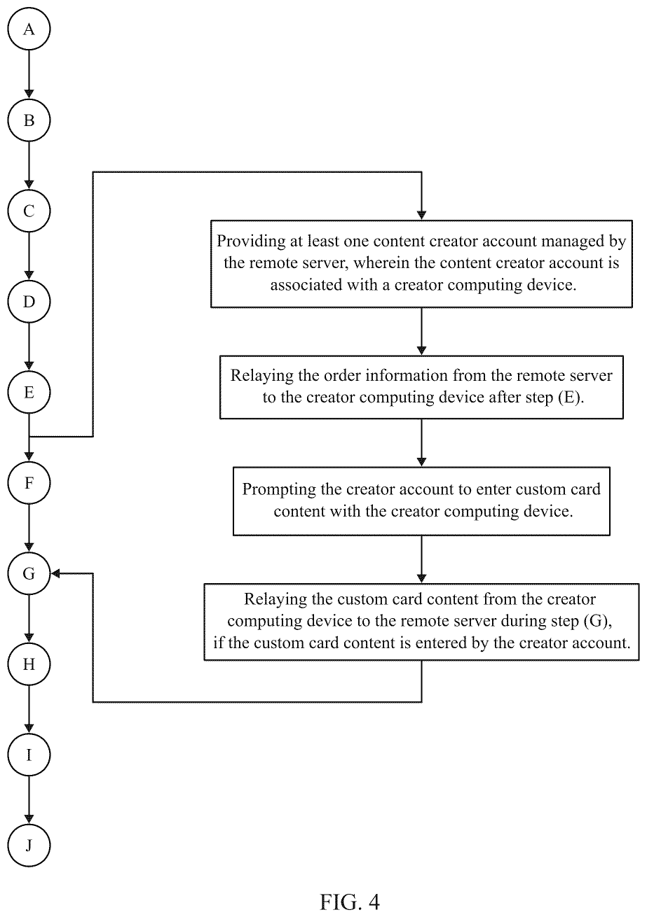

In some embodiments, the custom card content message or parts of the custom card content message can be generated by staff based on the order information. To enable the staff generate custom card content message, the system of the present invention may further include at least one content creator account managed by the remote server. The content creator account enables staff to access the software platform of the system to create custom card content message for the custom greeting card order. In addition, the content creator account is associated with a creator computing device that helps the user interact with the software platform. Like the client computing device, the creator computing device can be any computing device that allows the staff access the software platform of the present invention. For example, the creator computing device can include, but is not limited to, a desktop computer, a tablet computer, a laptop, a smartphone, etc. As can be seen in FIG. 4, the subprocess of generating custom card content message using human staff includes the steps of relaying the order information from the remote server to the creator computing device after Step E. All important information is relayed to the staff so that the staff can generate the custom card content message based on the order information. Once received, the creator account is prompted to enter custom card content message with the creator computing device. The custom card content message can be overseen by other staff to ensure the quality of the generated custom card content message. Further, the custom card content message is relayed from the creator computing device to the remote server during Step G, if the custom card content message is entered by the creator account. This way, the custom card content message generated by the staff is implemented on the custom greeting card order.

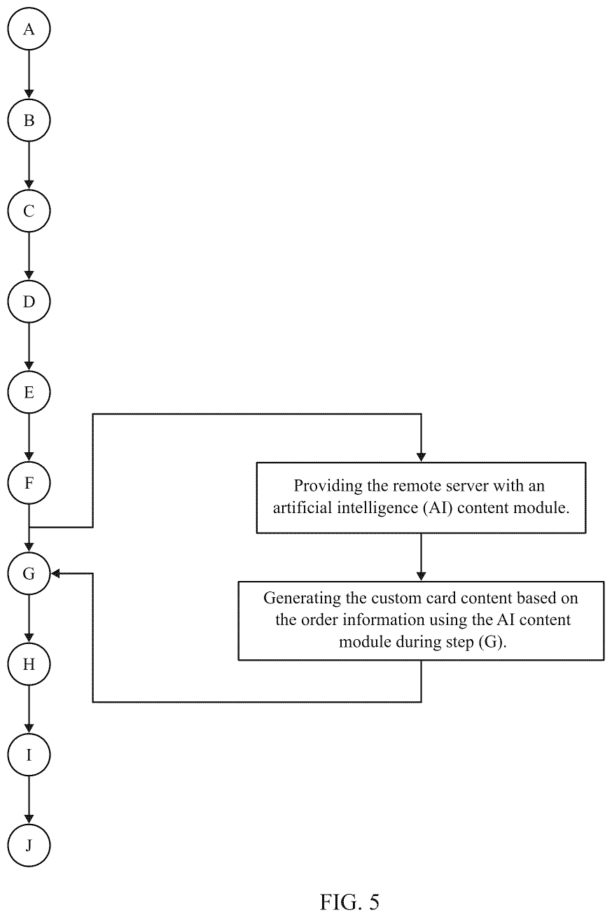

In another embodiment, the custom card content message or parts of the custom card content message can be automatically generated by an Artificial Intelligence (AI) engine based on the order information. To do so, the remote server is provided with an AI content module that is used to automatically generated custom card content message based on the order information provided by the client. The AI content module can include a proprietary AI engine or can utilize a third-party AI engine by implementing different communication protocols, such as the Application Programming Interface (API). As can be seen in FIG. 5, the subprocess of generating custom card content message using AI includes the step of generating the custom card content message based on the order information using the AI content module during Step G. In alternate embodiments, different automated systems can be implemented to automatically generate custom card content message.

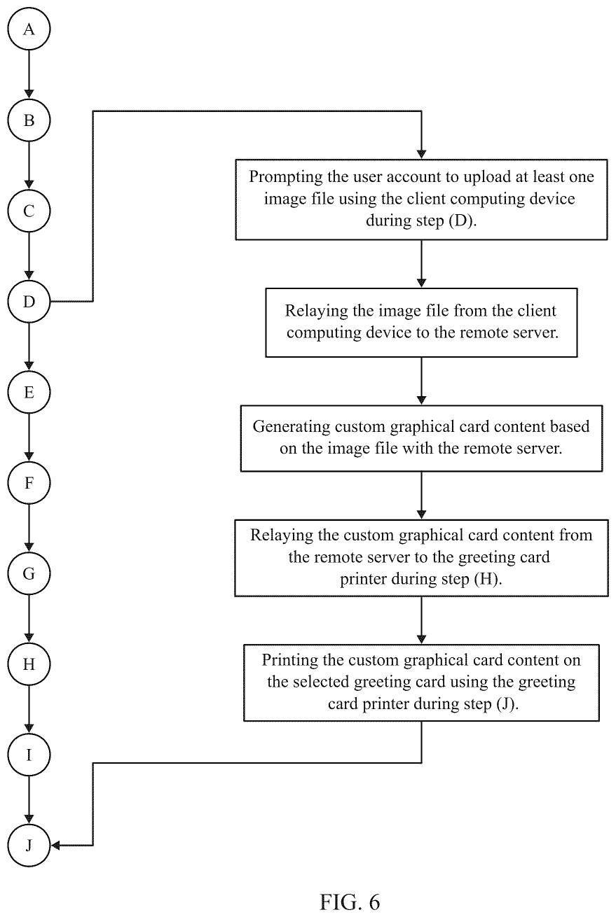

To increase the customization options for the selected greeting card, the present invention may also enable the client to upload one or more pictures that help personalize the custom greeting card. As can be seen in FIG. 6, the subprocess of customizing the selected greeting card using an uploaded picture includes the steps of prompting the user account to upload at least one image file using the client computing device during Step D. The image file can be stored on the client computing device or from a third-party data storage service. Next, the image file is relayed from the client computing device to the remote server so that custom graphical card content based on the image file can be generated with the remote server. The custom graphical card content can include the uploaded image file unaltered, or the uploaded image filed edited according to the client's order information. Moreover, the custom graphical card content is relayed from the remote server to the greeting card printer during Step H. Finally, the custom graphical card content is printed on the selected greeting card using the greeting card printer during Step J. In other embodiments, other media content can be utilized to further personalize the custom greeting card.

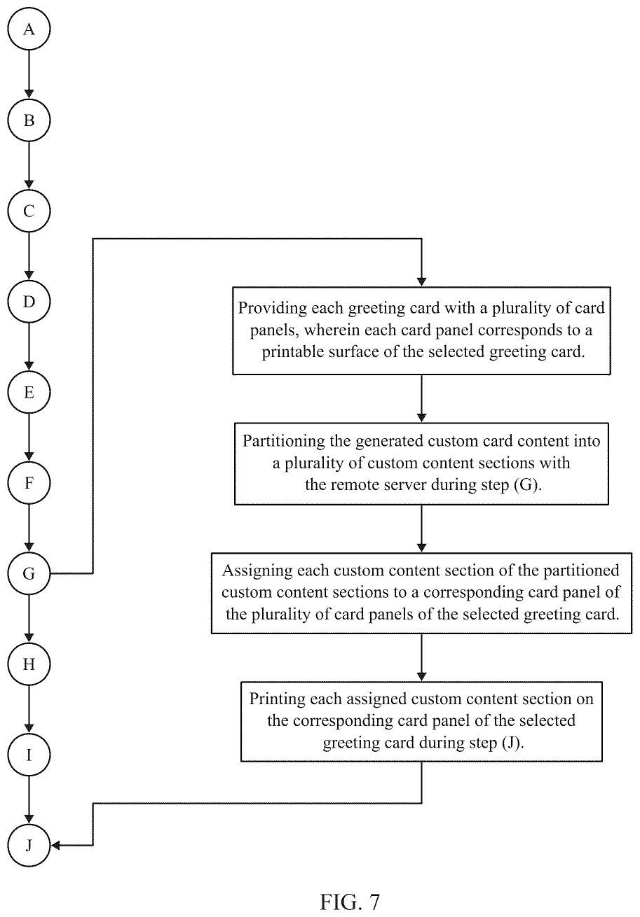

When generating the custom card content message, the different elements of the custom card content message can be generated for specific card panels of the selected greeting card. As previously discussed, each greeting card can include a plurality of card panels, wherein each card panel corresponds to a printable surface of the selected greeting card. For example, each greeting card can include a cover panel, a first internal panel, a second internal panel, and a rear panel once the greeting card has been folded. The generated custom card content message is distributed throughout the card panels according to the selected greeting card design and the client's order information. As can be seen in FIG. 7, the subprocess of distributing the custom card content message throughout the card panels of the selected greeting card includes the steps of partitioning the generated custom card content message into a plurality of custom content sections with the remote server during Step G. The custom content sections can be generated based on the design of the selected greeting card and/or the client's order information. Then, each custom content section of the partitioned custom content sections is assigned to a corresponding card panel of the plurality of card panels of the selected greeting card. This way, the custom content sections of the generated custom card content message are distributed according to the design of the selected greeting card and/or the client's order information. Further, each assigned custom content section is printed on the corresponding card panel of the selected greeting card during Step J. In other embodiments, different methods can be implemented to distribute the generated custom card content message.

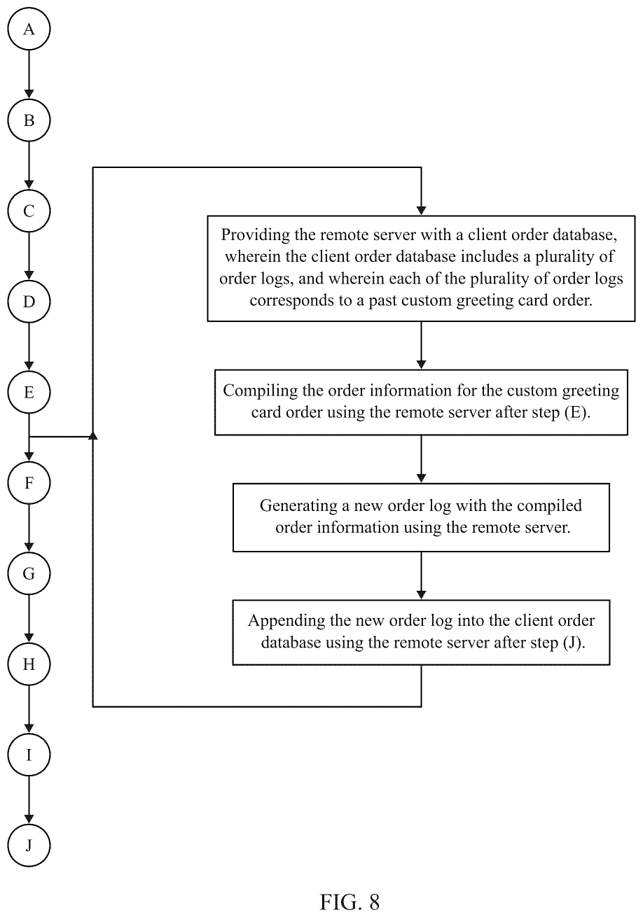

In the preferred embodiment, the system of the present invention can provide means to store past custom greeting card orders for a period of time for audit purposes or to allow the user to reorder a past custom greeting card order. So, the system of the present invention can provide the remote server with a client order database that stores past custom greeting card orders of a client for a period of time, preferably up to a year from the day the past order is completed. The client order database includes a plurality of order logs, wherein each of the plurality of order logs corresponds to a past custom greeting card order. As can be seen in FIG. 8, the subprocess of logging custom greeting card orders on the client order database includes the steps of compiling the order information for the custom greeting card order using the remote server after Step E. Specific order information can be compiled for auditing or to facilitate reordering including, but not limited to, calendar date the custom greeting card was shipped out, recipient, occasion/theme, custom card content message, etc. Moreover, a new order log is generated with the compiled order information using the remote server, which is then appended into the client order database using the remote server after Step J. This way, the client can access past custom greeting card orders, but after the period of time passes since the order was completed, the past custom greeting card order is deleted by the remote server.

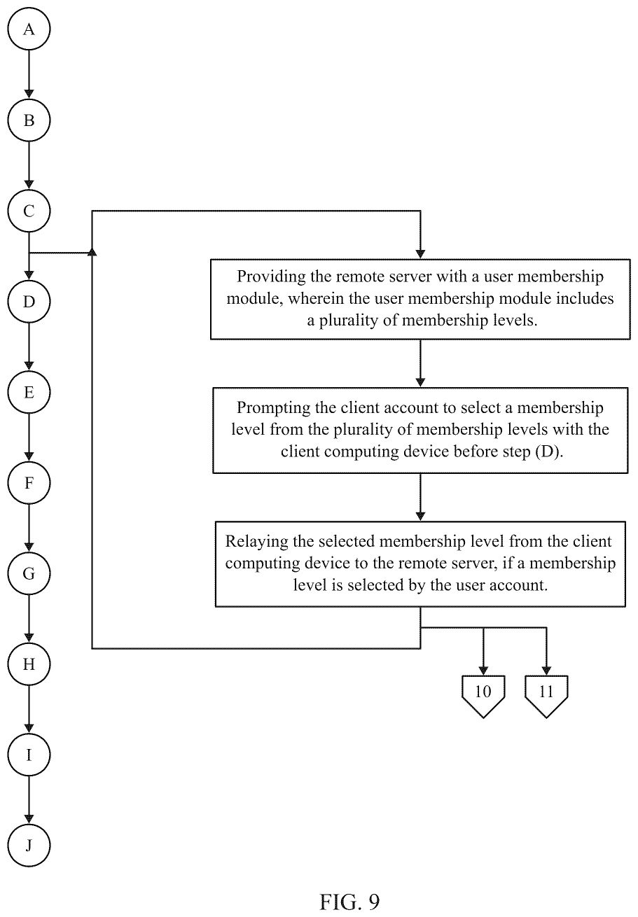

The system of the present invention can implement subscription services that give the client access to different services offered by the present invention according to the subscription acquired by the client. So, the remote server may further include a user subscription module that enables the implementation of subscriptions into the system of the present invention. The user subscription module includes a plurality of subscription levels, wherein each subscription level includes different perks or services available to the client. As can be seen in FIG. 9, the subprocess of acquiring a subscription of the present invention includes the steps of prompting the client account to select a subscription level from the plurality of subscription levels with the client computing device before Step D. Different subscription levels can be implemented including, but not limited to, a basic subscription level, a VIP subscription level, an enterprise subscription level, or a combination thereof. Each subscription level can have a different price according to the local currency as well as different subscription perks and services. Further, the selected subscription level from the client computing device is relayed to the remote server, if a subscription level is selected by the user account. Each subscription level can be renewed periodically (e.g., monthly, annually, etc.) using different payment methods predetermined by the present invention.

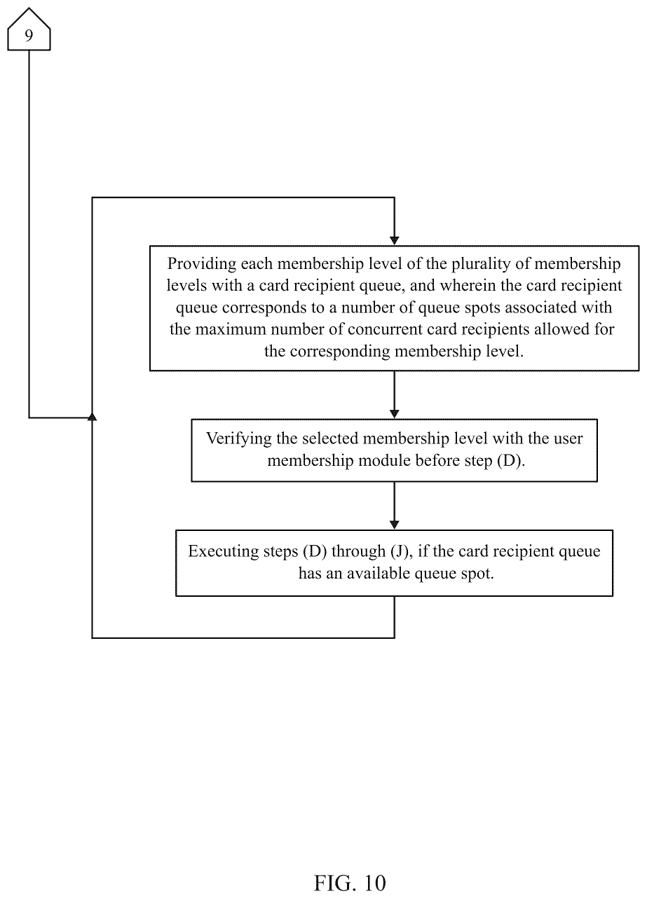

As previously discussed, the different subscription levels can include different perks and services available to the client. Different subscription levels can provide different limits on the amount of custom greeting card orders being placed during a time period. For example, the basic subscription can limit the order queue to 10 people maximum in the queue, the VIP subscription can limit the order queue to 20 people maximum in the queue, and the enterprise subscription can have an unlimited queue. The remote server enforces the queue limitation according to the subscription level of the client. As can be seen in FIG. 10, the subprocess of enforcing subscription level limitations includes the steps of verifying the selected subscription level with the user subscription module before Step D. The verification is performed automatically to not obstruct the process of generating the custom greeting card. Then, Steps D through J are executed, if the card recipient queue has an available queue spot. In other words, if the client's order queue has available queue spots according to the client's subscription level, then the client can proceed to place a new custom greeting card order.

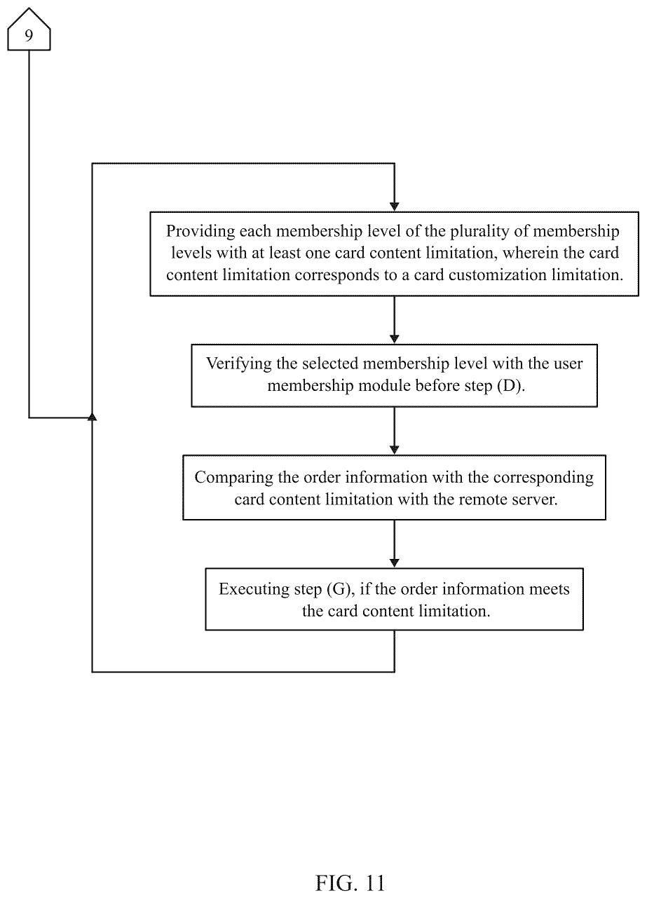

In addition to limiting the amount of custom greeting card orders the client can place simultaneously, the subscription levels can also limit the customization of the selected greeting card. So, each subscription level of the plurality of subscription levels is provided with at least one card content limitation, wherein the card content limitation corresponds to a card customization limitation. In some embodiments, different subscription levels can allow the use of different languages for the custom card content message. For example, the basic subscription can allow the user of a single language, the VIP subscription and the enterprise subscription can allow the user of multiple languages, etc. As can be seen in FIG. 11, the subprocess of enforcing the card content limitation based on the client's subscription level includes the steps of verifying the selected subscription level with the user subscription module before Step D. Like before, the verification process is automatic to expedite the custom greeting card creation process. Then, the order information is compared with the corresponding card content limitation with the remote server to determine if any requested card customization falls out of the card content limitations of the corresponding subscription level. For example, if the user requests multiple languages but the client's subscription level only allows one language, then an error message can be output with the client computing device to alert the user of the limitation. Finally, Step G is executed, if the order information meets the card content limitation. In other embodiments, different card customization limitations can be implemented for the different subscription levels, such as allowing the client to provide a picture for the front panel of the selected greeting card.

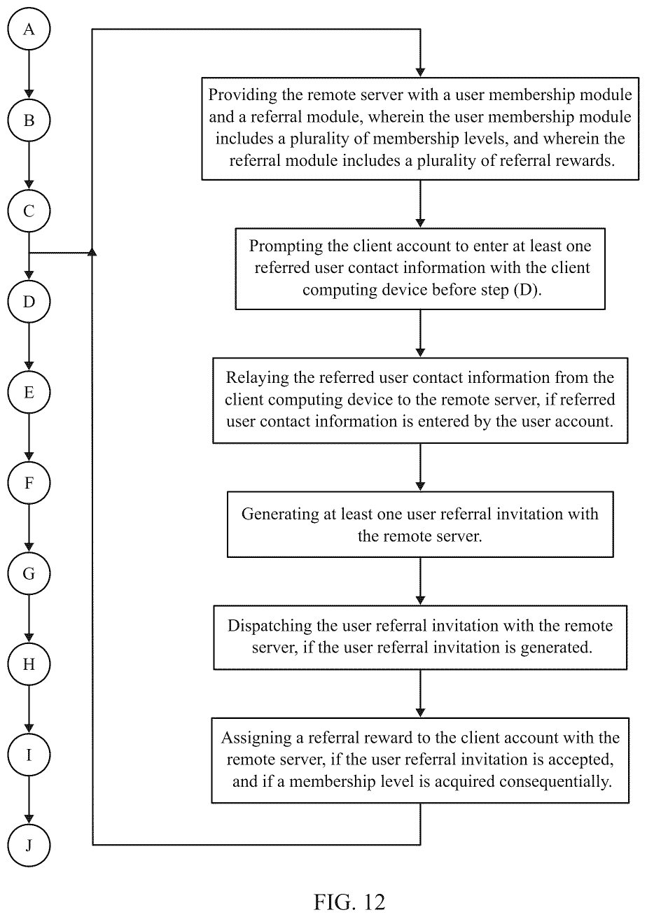

In addition to implementing subscriptions, the present invention can implement a referral system that allows the client to refer other users. So, the remote server can further include a referral module that enables the client to refer other clients to the services of the present invention. In addition, the referral module can include a plurality of referral rewards that encourages the client to refer other users to the present invention. As can be seen in FIG. 12, the subprocess of facilitating the referral of the present invention to other users includes the steps of prompting the client account to enter at least one referred user contact information with the client computing device before Step D. The referred user contact information can include, but is not limited to, email, phone number, or other means of communicating with the referred user. Then, the referred user contact information is relayed from the client computing device to the remote server, if referred user contact information is entered by the user account. Moreover, at least one user referral invitation is generated with the remote server, which is then dispatched with the remote server, if the user referral invitation is generated. The referral invitation is dispatched to the referred user according to the referred user contact information that was provided. For example, if an email is provided, the referral invitation is sent via email to the referred user's email.

Furthermore, a referral reward is assigned to the client account with the remote server, if the user referral invitation is accepted, and if a subscription level is acquired consequentially. In other words, the client receives a referral reward if the referred user accepts the invitation and acquires a subscription. Depending on the subscription acquired by the referred user, different referral rewards can be provided to the client. For example, if an individual is referred and buys a subscription for a year, the client is assigned a credit for a custom greeting card. If a business is referred that signs up 10 people or more, the client is assigned a credit of seven custom greeting cards. In other embodiments, different referral rewards and limitations can be implemented.

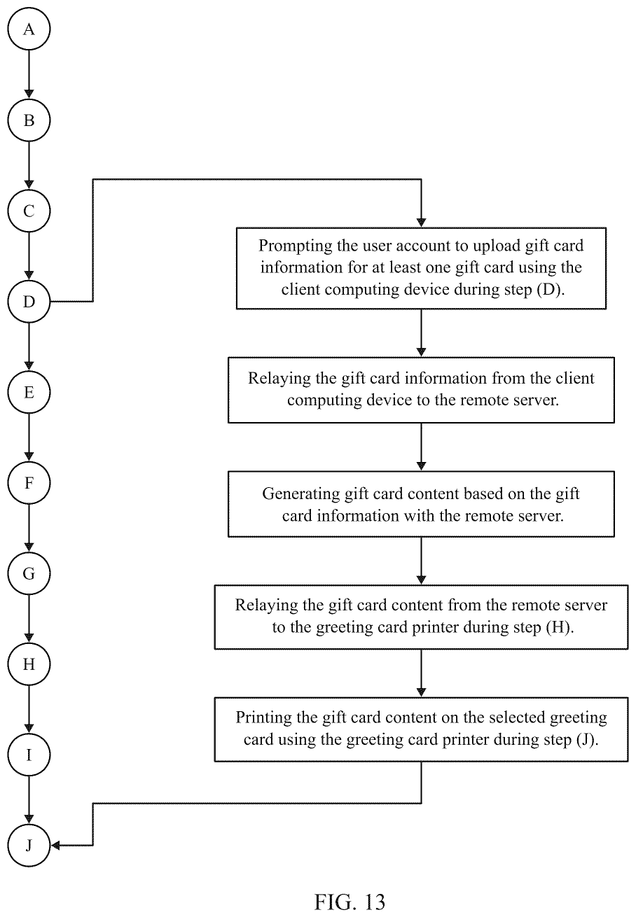

The system of the present invention can implement additional services that increase the customization options for the custom greeting card. In some embodiments, the system of the present invention can enable the client to include a gift card to be included with the custom greeting card. Greeting card information can be provided by the client to be included with the custom greeting card. Alternatively, the system of the present invention can implement means for the user to acquire the gift card, chocolates, flowers, restaurant cards, etc., from a third-party service through the system of the present invention. As can be seen in FIG. 13, the subprocess of including a gift card with the custom greeting card includes the steps of prompting the user account to upload gift card information for at least one gift card using the client computing device during Step D. The gift card information includes the necessary information for the recipient to redeem the gift card. Moreover, the gift card information is relayed from the client computing device to the remote server so that gift card content can be generated based on the gift card information with the remote server. For example, the gift card information can be implemented as part of the custom card content message or can be implemented separately from the custom card content message. Further, the gift card content is relayed from the remote server to the greeting card printer during Step H so that the gift card content can be printed on the selected greeting card using the greeting card printer during Step J. In other embodiments, different gift elements provided by the client can be further included in the custom greeting card that enhance the value of the custom greeting card.

In the preferred embodiment, each of the plurality of greeting cards can include a corresponding card envelop that can be used to safely ship the custom greeting card to the recipient. The card envelop also includes a corresponding matrix barcode that matches the information of the matrix barcode on the custom greeting card. This way, once the custom greeting card is generated and is ready to ship, the staff can place the custom greeting card in the card envelop and verify the recipient's information using the barcode terminal and the matrix barcode on the card envelop. In other embodiments, different verification elements can be applied to ensure that the custom greeting card is sent to the correct recipient.

Although the invention has been explained in relation to its preferred embodiment, it is to be understood that many other possible modifications and variations can be made without departing from the spirit and scope of the invention.

What is claimed is:

1. A method of generating a custom greeting card, the method comprising the steps of:
(A) providing at least one client account managed by at least one remote server, wherein the client account is associated with at least one client computing device, and wherein the remote server includes a matrix barcode module;
(B) providing at least one at least one greeting card printer and at least one barcode terminal managed by the remote server;
(C) providing a plurality of greeting cards, wherein each greeting card includes a corresponding matrix barcode, and wherein the matrix barcode is integrated on the rear panel of the corresponding greeting card;
(D) prompting the client account to enter order information for at least one custom greeting card order with the client computing device;
(E) relaying the order information from the client computing device to the remote server, if the order information is entered by the client account;
(F) editing the corresponding matrix barcode of a selected greeting card with the order information using the barcode terminal;
(G) generating custom card content message based on the order information with the remote server, wherein the custom card content message includes a plurality of content elements that can be applied to a selected greeting card;
(H) relaying the custom card content message from the remote server to the greeting card printer and the barcode terminal, if the custom card content message is generated by the card content module;
(I) verifying the selected greeting card with the corresponding matrix barcode using the barcode terminal; and
(J) printing the custom card content message on the selected greeting card using the greeting card printer, if the selected greeting card is verified by the barcode terminal.

2. The method as claimed in claim 1, wherein the order information includes recipient's name, recipient relationship, recipient address, preferred language, card theme, card due date, recipient relationship description, or a combination thereof.

3. The method as claimed in claim 1, wherein the custom card content message includes custom written content, custom graphical content, or a combination thereof.

4. The method as claimed in claim 1, wherein each greeting card of the plurality of greeting cards is a foldable blank card.

5. The method as claimed in claim 1 further comprising the steps of:
providing at least one content creator account managed by the remote server, wherein the content creator account is associated with a creator computing device;
relaying the order information from the remote server to the creator computing device after step (E);
prompting the creator account to enter custom card content message with the creator computing device; and
relaying the custom card content message from the creator computing device to the remote server during step (G), if the custom card content message is entered by the creator account.

6. The method as claimed in claim 1 further comprising the steps of:
providing the remote server with an artificial intelligence (AI) content module; and
generating the custom card content message based on the order information using the AI content module during step (G).

7. The method as claimed in claim 1 further comprising the steps of:
prompting the user account to upload at least one image file using the client computing device during step (D);
relaying the image file from the client computing device to the remote server;
generating custom graphical card content based on the image file with the remote server;
relaying the custom graphical card content from the remote server to the greeting card printer during step (H); and
printing the custom graphical card content on the selected greeting card using the greeting card printer during step (J).

8. The method as claimed in claim 1 further comprising the steps of:
providing each greeting card with a plurality of card panels, wherein each card panel corresponds to a printable surface of the selected greeting card;
partitioning the generated custom card content message into a plurality of custom content sections with the remote server during step (G);
assigning each custom content section of the partitioned custom content sections to a corresponding card panel of the plurality of card panels of the selected greeting card; and
printing each assigned custom content section on the corresponding card panel of the selected greeting card during step (J).

9. The method as claimed in claim 1 further comprising the steps of:
providing the remote server with a client order database, wherein the client order database includes a plurality of order logs, and wherein each of the plurality of order logs corresponds to a past custom greeting card order;
compiling the order information for the custom greeting card order using the remote server after step (E);
generating a new order log with the compiled order information using the remote server; and
appending the new order log into the client order database using the remote server after step (J).

10. The method as claimed in claim 1 further comprising the steps of:
providing the remote server with a user subscription module, wherein the user subscription module includes a plurality of subscription levels;
prompting the client account to select a subscription level from the plurality of subscription levels with the client computing device before step (D); and
relaying the selected subscription level from the client computing device to the remote server, if a subscription level is selected by the user account.

11. The method as claimed in claim 10 further comprising the steps of:
providing each subscription level of the plurality of subscription levels with a card recipient queue, and wherein the card recipient queue corresponds to a number of queue spots associated with the maximum number of concurrent card recipients allowed for the corresponding subscription level;
verifying the selected subscription level with the user subscription module before step (D); and
executing steps (D) through (J), if the card recipient queue has an available queue spot.

12. The method as claimed in claim 10 further comprising the steps of:
providing each subscription level of the plurality of subscription levels with at least one card content limitation, wherein the card content limitation corresponds to a card customization limitation;
verifying the selected subscription level with the user subscription module before step (D);
comparing the order information with the corresponding card content limitation with the remote server; and
executing step (G), if the order information meets the card content limitation.

13. The method as claimed in claim 12, wherein the card content limitation is a content language limitation.

14. The method as claimed in claim 1 further comprising the steps of:
providing the remote server with a user subscription module and a referral module, wherein the user subscription module includes a plurality of subscription levels, and wherein the referral module includes a plurality of referral rewards;
prompting the client account to enter at least one referred user contact information with the client computing device before step (D);
relaying the referred user contact information from the client computing device to the remote server, if referred user contact information is entered by the user account;
generating at least one user referral invitation with the remote server;
dispatching the user referral invitation with the remote server, if the user referral invitation is generated; and
assigning a referral reward to the client account with the remote server, if the user referral invitation is accepted, and if a subscription level is acquired consequentially.

15. The method as claimed in claim 1 further comprising the steps of:
prompting the user account to upload gift card information for at least one gift card using the client computing device during step (D);
relaying the gift card information from the client computing device to the remote server;
generating gift card content based on the gift card information with the remote server;
relaying the gift card content from the remote server to the greeting card printer during step (H); and
printing the gift card content on the selected greeting card using the greeting card printer during step (J).
